(19) United States
(12) Patent Application Publication
(10) Pub. No.: US 2014/0062941 A1
(43) Pub. Date: Mar. 6, 2014

(54) TOUCH SCREEN DISPLAY DEVICES

(71) Applicant: ELECTRONICS AND TELECOMMUNICATIONS RESEARCH IN, Daejeon (KR)

(72) Inventor: Rae-Man PARK, Daejeon (KR)

(73) Assignee: Electronics and Telecommunications Research Institute, Daejeon (KR)

(21) Appl. No.: 13/709,930

(22) Filed: Dec. 10, 2012

(30) Foreign Application Priority Data
Sep. 6, 2012 (KR) 10-2012-0098923

(51) Int. Cl. G06F 3/044

(52) U.S. Cl. CPC G06F 3/044
USPC 345/174

(57) ABSTRACT

Touch screen display devices are disclosed. The touch screen display device may include a first substrate, a first sensor line extending in a first direction on the first substrate, an optical switching layer on the first sensor line, a second substrate on the optical switching layer, a second sensor line extending in a second direction crossing the first direction on the second substrate, an interlayer insulating layer on the second sensor line, and a third sensor line extending in the first direction on the interlayer insulating layer. At least one of the second and third sensor lines may sense a variation of a current or a capacitance from the first sensor line when a distance between the first sensor line and the second substrate is changed.

### CROSS-REFERENCE TO RELATED APPLICATIONS

This U.S. non-provisional patent application claims priority under 35 U.S.C. §119 to Korean Patent Application No. 10-2012-0098923, filed on Sep. 6, 2012, the entirety of which is incorporated by reference herein.

### BACKGROUND

The inventive concept relates to display devices and, more particularly, to touch screen display devices.

Recently, touch screen display devices are highlighted with the development of smart phones. A touch input technique may generate an input signal by touching a screen. The touch input technique may be applied to various electronic/communication devices such as a notebook computer, a personal digital assistant (PDA), a game console, and/or a portable phone.

The iphone of Apple inc. is famous as a smart phone. The iphone may use a touch screen display device driven in a capacitive type. The touch screen display device may two-dimensionally sense location information of a finger. The touch screen display device may display an image by distortion of light. The touch screen display device may provide a clean image and may not influence the exterior of a product.

However, a conventional touch screen display device does not sense a finger of a user wearing gloves. This is because the gloves are insulators shielding static electricity of the human body. Almost of touch screen techniques of the capacitive type may sense a change of a capacitance induced from a charged object. The charged object may limitedly exist in the natural world. However, customers may demand various products including the touch screen display devices of the capacitive type.

### SUMMARY

Embodiments of the inventive concept may provide touch screen display devices capable of three-dimensionally sensing a finger touch and methods of manufacturing the same.

In one aspect, a touch screen display device may include: a first substrate; a first sensor line extending in a first direction on the first substrate; an optical switching layer on the first sensor line; a second substrate on the optical switching layer; a second sensor line extending in a second direction crossing the first direction on the second substrate; an interlayer insulating layer on the second sensor line; and a third sensor line extending in the first direction on the interlayer insulating layer. At least one of the second and third sensor lines may sense a variation of a current or a capacitance from the first sensor line when a distance between the first substrate and the second substrate is changed.

In an embodiment, the touch screen display device may further include: a gate line and a data line disposed between the first substrate and the first sensor line.

In an embodiment, the touch screen display device may further include: a pixel electrode in a pixel region defined by the gate line and the data line; and a thin film transistor connected to the pixel electrode.

In an embodiment, the touch screen display device may further include: a first passivation layer covering the pixel electrode and the thin film transistor, the first passivation layer disposed between the first sensor line and the first substrate.

In an embodiment, the touch screen display device may further include: a common electrode spaced apart from the pixel electrode.

In an embodiment, the common electrode may be disposed between the optical switching layer and the second substrate.

In an embodiment, the optical switching layer may include a nematic mode liquid crystal.

In an embodiment, the common electrode may be disposed between the first substrate and the first passivation layer.

In an embodiment, the optical switching layer may include an in-plane switching mode liquid crystal.

In an embodiment, the touch screen display device may further include: a fourth sensor line disposed between the second substrate and the optical switching layer and extending in the second direction.

In an embodiment, the touch screen display device may further include: a second passivation layer disposed between the fourth sensor line and the common electrode.

In an embodiment, the optical switching layer may include a liquid crystal layer doped with conductive impurities.

In an embodiment, the conductive impurities may include carbon.

In an embodiment, the second sensor line may include bridge electrodes disposed between the second substrate and the interlayer insulating layer, and separation electrodes electrically connected to each other by the bridge electrodes at both sides of the interlayer insulating layer.

In an embodiment, the touch screen display device may further include: a third substrate covering the second substrate, the separation electrodes, and the third sensor line.

In an embodiment, the third substrate may include a glass or plastic.

In an embodiment, the touch screen display device may further include: a planarization layer planarizing a space between the bridge electrodes and disposed between the second substrate and third substrate.

In an embodiment, the touch screen display device may further include: a first polarizing plate disposed under the first substrate; and a second polarizing plate disposed between the planarization layer and the second substrate.

In another aspect, a touch screen display device may include: a display panel including first and second substrates opposite to each other, an liquid crystal layer between the first and second substrates, a first sensor line extending in a first direction between the liquid crystal layer and the first substrate, and a second sensor line extending in a second direction crossing the first direction; and a touch panel including a third sensor line extending in the first direction on the display panel, an interlayer insulating layer on the third sensor line, and a fourth sensor line extending in the second direction on the interlayer insulating layer.

In an embodiment, the touch screen display device may further include: a first polarizing plate disposed under a bottom surface of the display panel opposite to the touch panel, the first polarizing plate polarizing light in the first direction; and a second polarizing plate disposed between the display panel and the touch panel, the second polarizing plate polarizing light in the second direction.

### BRIEF DESCRIPTION OF THE DRAWINGS

The inventive concept will become more apparent in view of the attached drawings and accompanying detailed description.

FIG. 1 is a plan view illustrating a touch screen display device according to a first embodiment of the inventive concept;

FIG. 2 is a cross-sectional view taken along a line I-I′ of FIG. 1;

FIGS. 3 to 13 are cross-sectional views illustrating a method of manufacturing a touch screen display device according to a first embodiment of the inventive concept;

FIG. 14 is a plan view illustrating a touch screen display device according to a second embodiment of the inventive concept;

FIG. 15 is a cross-sectional view taken along a line II-II′ of FIG. 14;

FIGS. 16 to 20 are cross-sectional views illustrating a method of manufacturing a touch screen display device according to a second embodiment of the inventive concept;

FIG. 21 is a cross-sectional view illustrating a touch screen display device according to a third embodiment of the inventive concept; and

FIG. 22 is a cross-sectional view illustrating a touch screen display device according to a fourth embodiment of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

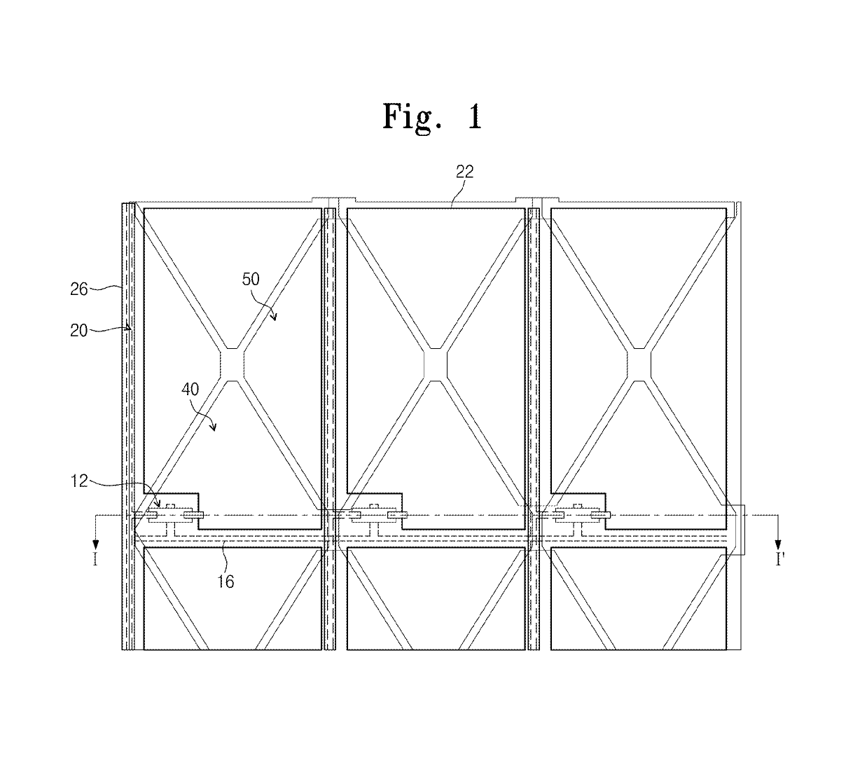

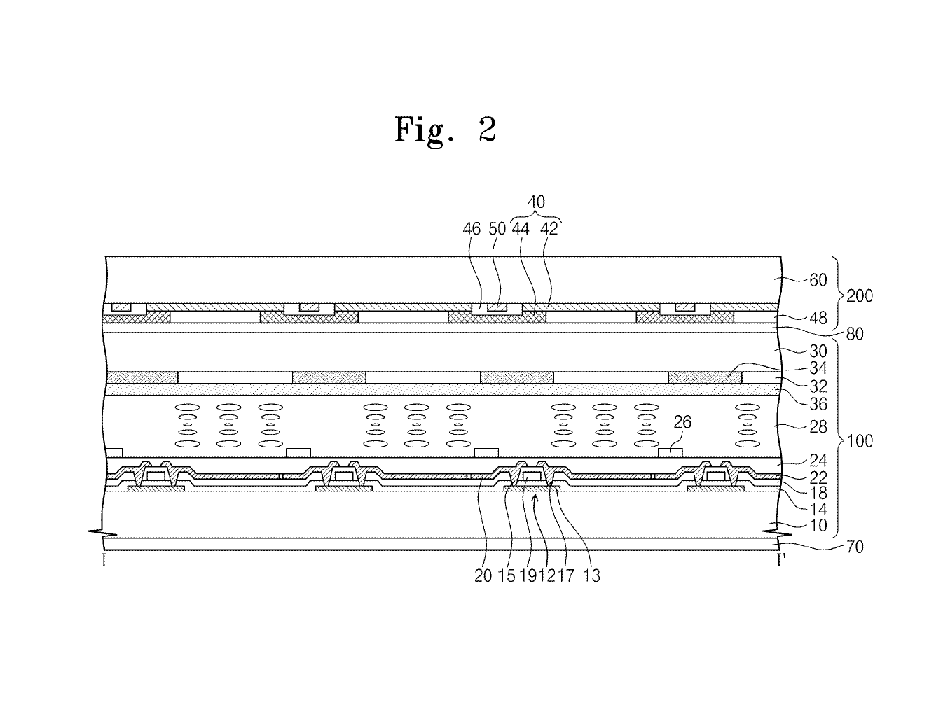

FIG. 1 is a plan view illustrating a touch screen display device according to a first embodiment of the inventive concept. FIG. 2 is a cross-sectional view taken along a line I-I′ of FIG. 1.

Referring to FIGS. 1 and 2, a touch screen display device according to a first embodiment may include a display panel 100 and a touch panel 200.

The display panel 100 may be disposed under the touch screen 200. The display panel 100 may be disposed between a first polarizing plate 70 and a second polarizing plate 80. The first polarizing plate 70 may polarize light. The polarized light may be controlled in the display panel 100. The display panel 100 may distort or transmit the light individually in each pixel. A polarization direction of the first polarizing plate 70 may be different from a polarization direction of the second polarizing plate 80. The second polarizing plate 80 may block the light polarized by the first polarizing plate 70 and transmit the distorted light.

The display panel 100 may include a lower substrate 10, thin film transistors 12, gate lines 16, an upper gate insulating layer 18, data lines 20, pixel electrodes 22, a first passivation layer 24, first sensor lines 26, a liquid crystal layer 28, an upper substrate 30, color filters 32, a black matrix layer 34, and a common electrode 36.

The lower substrate 10 and the upper substrate 30 are disposed to be opposite to each other. The lower substrate 10 and the upper substrate 30 may include a transparent glass or plastic.

The thin film transistors 12 are disposed on the lower substrate 10. The thin film transistors 12 may be disposed to be adjacent to crossing regions of the data lines 20 and the gate lines 16, respectively. The thin film transistor 12 is connected to the data line 20, the gate line, and the pixel electrode 22. The thin film transistor 12 may have an active layer 13, a gate insulating layer 14, source/drain electrodes 15 and 17, and a gate electrode 19. The active layer 13 may include poly-silicon. The thin film transistor 12 may have a top gate structure or a bottom gate structure according to positions of the active layer 13 and the gate line 16. The source/drain electrodes 15 and 17 and the gate electrode 19 may include a transparent metal. The transparent metal may include indium-tin oxide (ITO) and/or indium-zinc oxide (IZO). Each of the gate insulating layer 14 and the upper gate insulating layer 18 may include a silicon oxide layer.

The gate insulating layer 14 may be disposed on the active layer 13 and the lower substrate 10. The gate line 16 may be disposed on the gate insulating layer 14. The gate line 16 is connected to the gate electrode 19. The gate line 16 may transmit a scan signal or a gate signal to the thin film transistor 12. The upper gate insulating layer 18 may cover the gate line 16 and the gate insulating layer 14.

The data lines 20 may be disposed on the upper gate insulating layer 18. The data line 20 is connected to the source electrode 15. The data line 20 may transmit a data signal to the thin film transistor 12. The data line 20 may extend in a first direction, and the gate line 16 may extend in a second direction. The second direction may be different from the first direction. The data lines 20 and the gate lines 16 may be arranged in a matrix form.

The pixel electrode 22 is disposed in a pixel region defined by the data lines 20 and the gate lines 16. The pixel electrode 22 is spaced apart from the data lines 20 and is disposed on the upper gate insulating layer 18. The pixel electrode 22 may be a transparent electrode 22. The transparent electrode may include ITO.

The first passivation layer 24 covers the thin transistors 12, the pixel electrodes 22, and the data lines 20. The first passivation layer 24 may include a silicon oxide layer.

The first sensor lines 26 may be disposed on the first passivation layer 25. The first sensor lines 26 may extend in the first direction. The first sensor lines 26 may be transparent electrodes. Operation of the first sensor lines 26 will be described along with the touch panel 200 later.

The color filters 32 may be disposed on the upper substrate 30. The color filters 32 may be disposed over the pixel electrodes 22 in one-to-one correspondence. Each of the color filters 32 may have one of a red color, a green color, and a blue color.

The black matrix layer 34 may be disposed between the color filters 32. The black matrix layer 34 may prevent light leakage. The light leakage means that the light leaks out of the pixel electrode 22 and the color filter 32. Thus, the black matrix layer 34 may be disposed on the gate lines 16 and the data lines 20.

The common electrode 36 may be disposed on an entire bottom surface of the upper substrate 30. The common electrode 36 may be a transparent electrode. The common electrode 36 may be applied with a ground voltage. If the pixel electrode 22 is applied with a predetermined voltage, an electric field may be induced between the common electrode 36 and the pixel electrode 22.

The liquid crystal layer 28 may be an optical switching layer controlling the transmitting light to the lower and upper substrate 10 and 30. The liquid crystal layer 28 may include a nematic mode liquid crystal (e.g., a twisted nematic (TN) liquid crystal). If the electric field is not generated, the liquid crystal layer 28 may change a phase of the polarized light by an angle of about 90 degrees. At this time, the light may be blocked by the second polarizing plate 80. Alternatively, if the electric field is generated, the polarized light may pass through the liquid crystal layer 28 without the phase change. The light may also pass through the second polarizing plate 80 to be displayed into an image. Thus, the display panel 100 may display the image. The liquid crystal layer 28 may be doped with conductive impurities. The conductive impurities may include carbon.

If an external pressure may be applied to the touch panel 200 to change of the arrangement of the liquid crystal layer 28, resistance variation may be sensed. A resistance between the first sensor line 26 and the common electrode 36 may increase. In other words, if the arrangement of the liquid crystal layer 28 may get out of order, electric conductivity may be reduced. The electric conductivity may increase depending on an arrangement degree of the liquid crystal layer 28. In other words, the electric conductivity may be progressively changed depending on an intensity of the external pressure. Thus, a vertical coordinate (i.e., a z-coordinate) to the touch panel 200 may be determined depending on the intensity of the external pressure. Additionally, the touch panel 200 may recognize two-dimensional position coordinates (i.e., an x-coordinate and a y-coordinate).

As a result, the touch screen display device according to the first embodiment may three-dimensionally sense a touch of a user.

The touch panel 200 may be disposed on the display panel 100. The touch panel 200 may be driven in a capacitive type. The touch panel 200 may include second sensor lines 40, an interlayer insulating layer 46, a planarization layer 48, third sensor lines 50, and a cover substrate 60.

The second sensor lines 40 and the third sensor lines 50 may be transparent electrodes. The second sensor lines 40 may extend in the second direction. The second sensor lines 40 may include separation-electrodes 42 and bridge electrodes 44. The separation-electrodes 42 may be disposed on the pixel electrodes 22. The separation-electrodes 42 may be disposed between the third sensor lines 50. The bridge electrodes 44 may connect the separation-electrodes 42 to each other. The bridge electrodes 44 may be disposed on the third sensor lines 50.

The interlayer insulating layer 46 may be disposed between the bridge electrode 44 and the third sensor line 50. The interlayer insulating layer 46 may cover the third sensor lines 50. The interlayer insulating layer 46 may include a dielectric such as silicon oxide and/or silicon nitride. The dielectric may have a capacitance. The dielectric may include dielectric polarization and a dielectric constant. The dielectric polarization of the interlayer insulating layer 46 may be arranged in one direction according to an electric field between the second sensor line 40 and the third sensor line 50. Additionally, if first charges are applied to one of the second sensor line 40 and the third sensor line 50, second charges may be induced in the other of the second and third sensor lines 40 and 50. The first charge and the second charge have polarities opposite to each other, respectively. The interlayer insulating layer 46 may have a capacitance. The capacitance of the interlayer insulating layer 46 may be proportional to the dielectric constant of the dielectric and be inversely proportional to a thickness of the interlayer insulating layer 46.

The third sensor lines 50 may extend in the first direction. The third sensor lines 50 may be disposed between the separation-electrodes 42. The separation-electrodes 42 may be disposed at the same level as the third sensor lines 50 from the cover substrate 60.

The planarization layer 48 may cover the separation-electrodes 42 and the third sensor lines 50. The bridge electrodes 44 may be exposed from the planarization layer 48. The planarization layer 48 may include a silicon oxide layer.

The cover substrate 60 may include a transparent glass or plastic. The glass may include a silicon oxide layer. The silicon oxide layer is a dielectric. The cover substrate 60 may insulate the second sensor lines 40 and the third sensor lines 50.

If a finger of a user touches the cover substrate 60, the second sensor lines 40 and the third sensor lines 50 may sense variation of the capacitance. The human body may have static electricity of a predetermined amount or more. The finger of the human body may generate a variable capacitance from the second sensor line 40 or the third sensor line 50 through the cover substrate 60. Thus, a total capacitance between the second sensor line 40 and the third sensor line 50 may be reduced by the variable capacitance. The touch panel 200 may generate an input signal of two-dimensional position coordinates (i.e., x and y-coordinates). The two-dimensional position coordinates may correspond to one of crossing points of the second sensor lines 40 and the third sensor lines 50.

If an external pressure is applied to the cover substrate 60, the capacitance between the first sensor line 26 and at least one of the second and third sensor lines 40 and 50 may be varied. For example, if the finger of the user presses the touch panel 200, a distance between the lower substrate 10 and the upper substrate 30 may be reduced. In other words, the liquid crystal layer 28 may become thinner The capacitance may increase in inverse proportion to the thickness of the liquid crystal layer 28. In other words, the capacitance is proportional to the intensity of the pressing force of the finger. Thus, the touch panel 200 may generate an input signal of three-dimensional position coordinates (i.e., x, y, and z-coordinates).

As a result, the touch screen display device according to the first embodiment may three-dimensionally sense the touch.

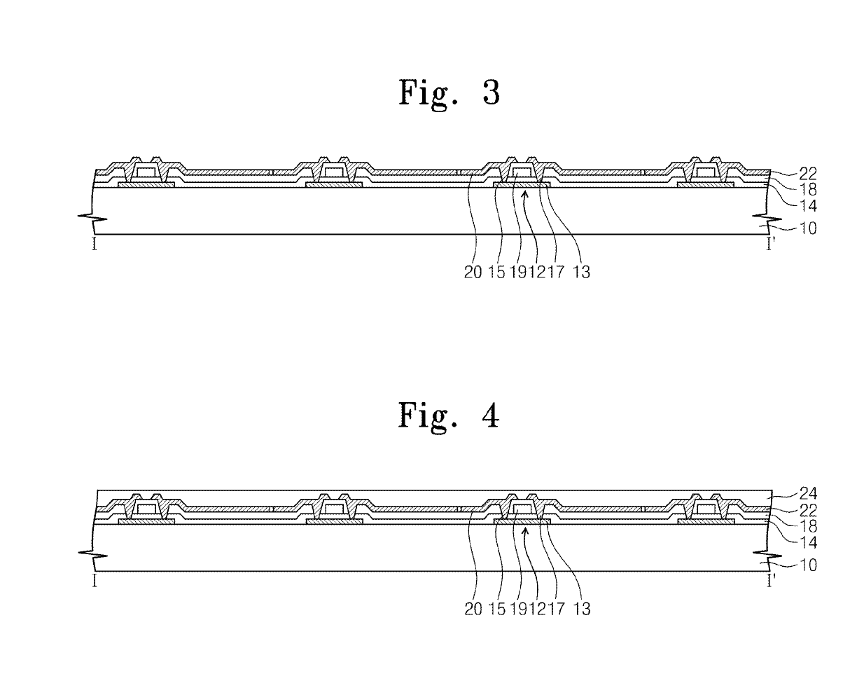

A method of manufacturing the touch screen display device will be described with reference to FIGS. 3 to 13.

FIGS. 3 to 13 are cross-sectional views illustrating a method of manufacturing a touch screen display device according to a first embodiment of the inventive concept. FIGS. 3 to 13 are cross-sectional views taken along the line I-I′ of FIG. 1.

Referring to FIGS. 1 and 3, the thin film transistors 12, the gate lines 16, the data lines 20, and the pixel electrodes 22 may be formed on the lower substrate 10. The thin film transistors 12 may be formed by unit-processes including depositing processes of an active layer 13, a metal layer, and an insulating layer, photolithography processes, and etching processes. The active layer 13 may include poly-silicon formed by a chemical vapor deposition (CVD) process. The active layer 13 may be patterned by the photolithography process and the etching process. The gate insulating layer 14 and the upper gate insulating layer 18 may include silicon oxide layers, respectively. The silicon oxide layers may be formed on an entire surface of the lower substrate 10 by CVD processes. The gate line 16 and the gate electrode 19 of the thin film transistor 12 may be formed on the gate insulating layer 14. The gate electrode 19 may be formed over the active layer 13 by patterning the metal layer. The gate electrode 19 may be connected to the gate line 16. The upper gate insulating layer 18 may be formed on the gate electrode 19, the gate line 16, and the gate insulating layer 14.

The upper gate insulating layer 18 and the gate insulating layer 14 may be successively patterned to form contact holes (not shown). The contact holes may be spaced apart from the gate electrode 19. The contact holes may penetrate the upper gate insulating layer 18 and the gate insulating layer 14 to expose the active layer 13 at both sides of the gate electrode 19. Source/drain electrodes 15 and 17 may be formed in the contact holes, respectively. The source/drain electrodes 15 and 17 may be connected to the gate line 20 and the pixel electrode 22, respectively. The data line 20 and the pixel electrode 22 may include a transparent metal formed by a unit process. The transparent metal may include ITO and IZO.

Referring to FIG. 4, the first passivation layer 24 may be formed on the thin film transistors 12 and the pixel electrode 22. The first passivation layer 24 may include a silicon oxide layer formed by a CVD process.

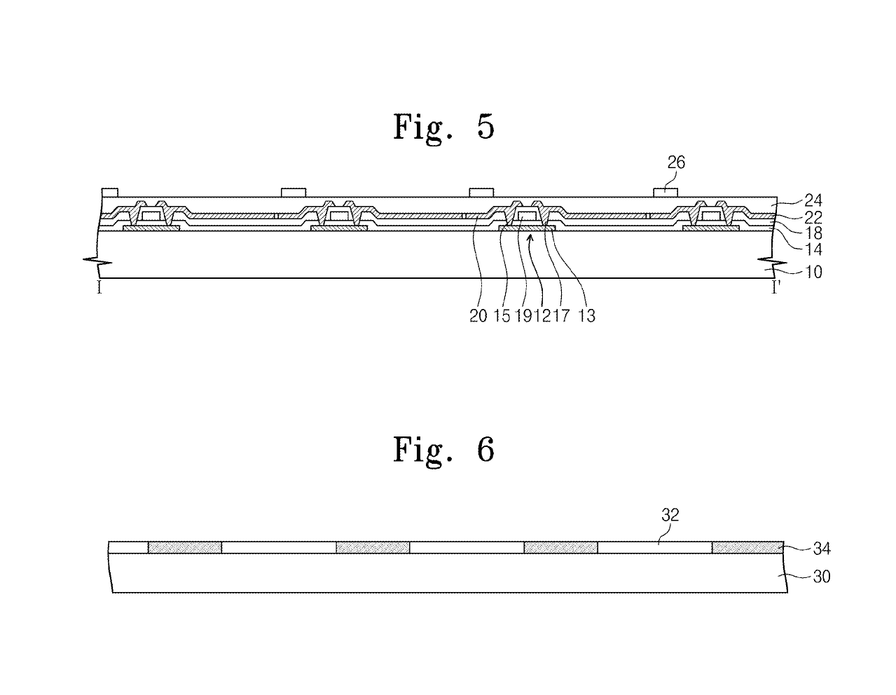

Referring to FIG. 5, the first sensor lines 26 may be formed on the first passivation layer 24. The first sensor lines 26 may be formed over the data lines 20. The first sensor lines 26 may be formed by a depositing process, a photolithography process, and an etching process. The depositing process for the first sensor lines 26 may include a sputtering process for a transparent electrode.

Referring to FIG. 6, the color filters 32 and the black matrix layer 34 may be formed on the upper substrate 30. The color filters 32 may include dyes respectively having a red color, a green color, and a blue color. The black matrix layer 34 may include a black dye printed on the upper substrate 30. The dyes may be printed on the upper substrate 30.

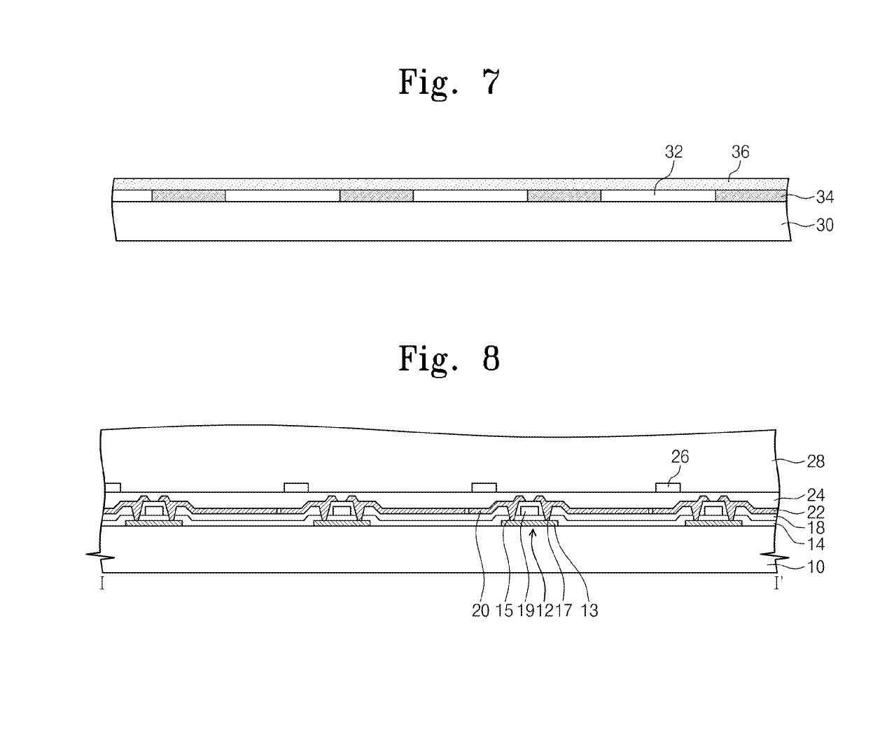

Referring to FIG. 7, a common electrode 36 may be formed on the color filters 32 and the black matrix layer 34. The common electrode 36 may be formed on an entire surface of the upper substrate 30. The common electrode may include a transparent metal. The transparent metal may be formed by a sputtering process.

Referring to FIG. 8, a liquid crystal layer 28 may be provided on the first sensors 26 and the first passivation layer 24 of the lower substrate 10. The liquid crystal layer 28 may drop on the lower substrate 10.

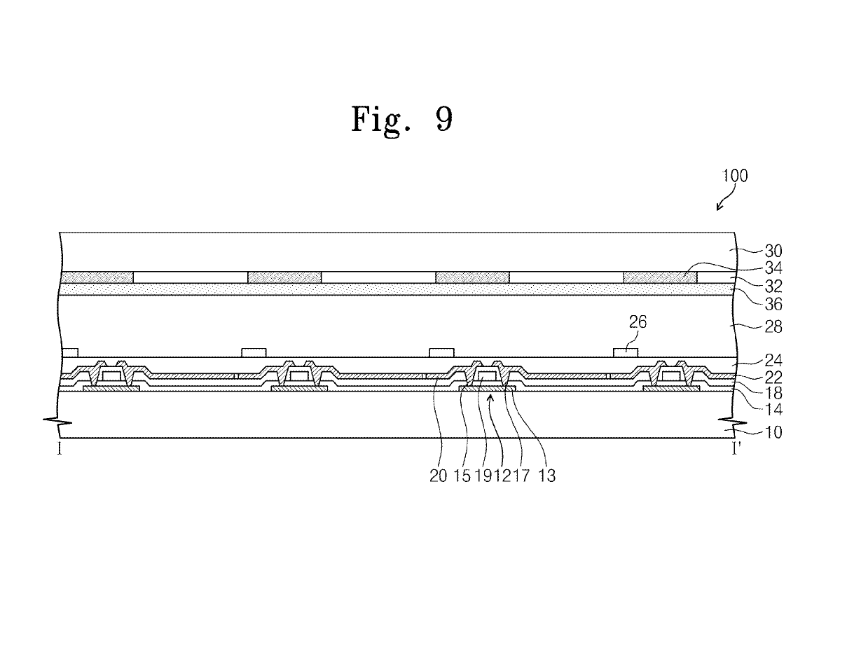

Referring to FIG. 9, the lower substrate 10 and the upper substrate 30 are bonded to each other. The pixel electrodes 22 are aligned with color filters 32, respectively. The lower substrate 10 and the upper substrate 30 may be bonded to each other to be fixed by a sealant (not shown). Thus, the manufacture of the display panel 100 may be finished.

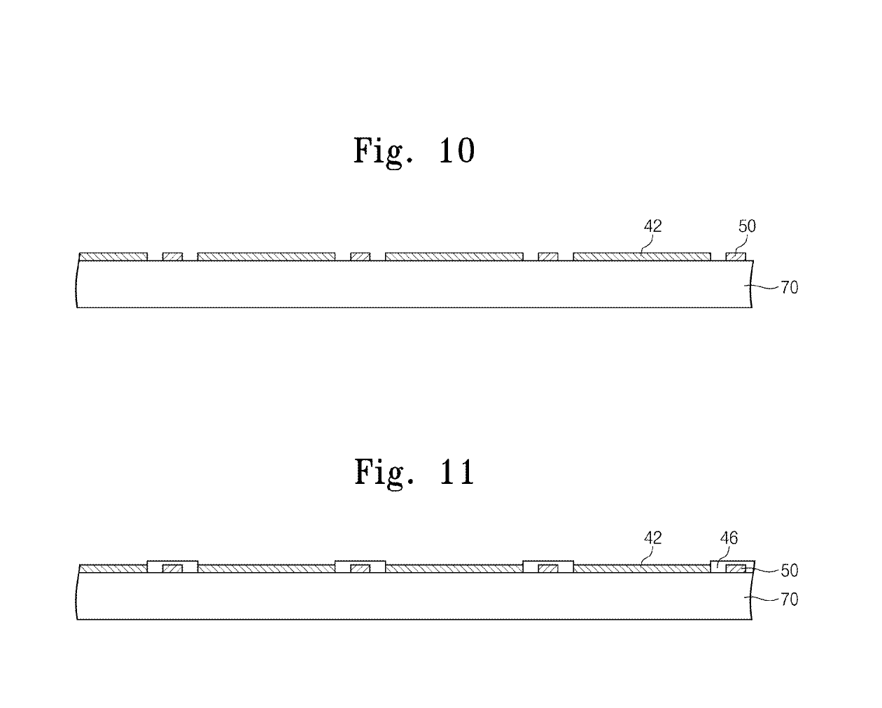

Referring to FIG. 10, the third sensor lines 50 and the separation electrodes 42 may be formed on a cover substrate 60. The third sensor lines 50 and the separation electrodes 42 may include a transparent metal such as ITO and/or IZO. The third sensor lines 50 and the separation electrodes 42 may be formed by a depositing process, a photolithography process, and an etching process. The depositing process may include a sputtering process.

Referring to FIG. 11, the interlayer insulating layer 46 may be formed on the third sensor lines 50, the separation electrodes 42, and the cover substrate 60. The interlayer insulating layer may include a silicon oxide layer formed by a CVD process.

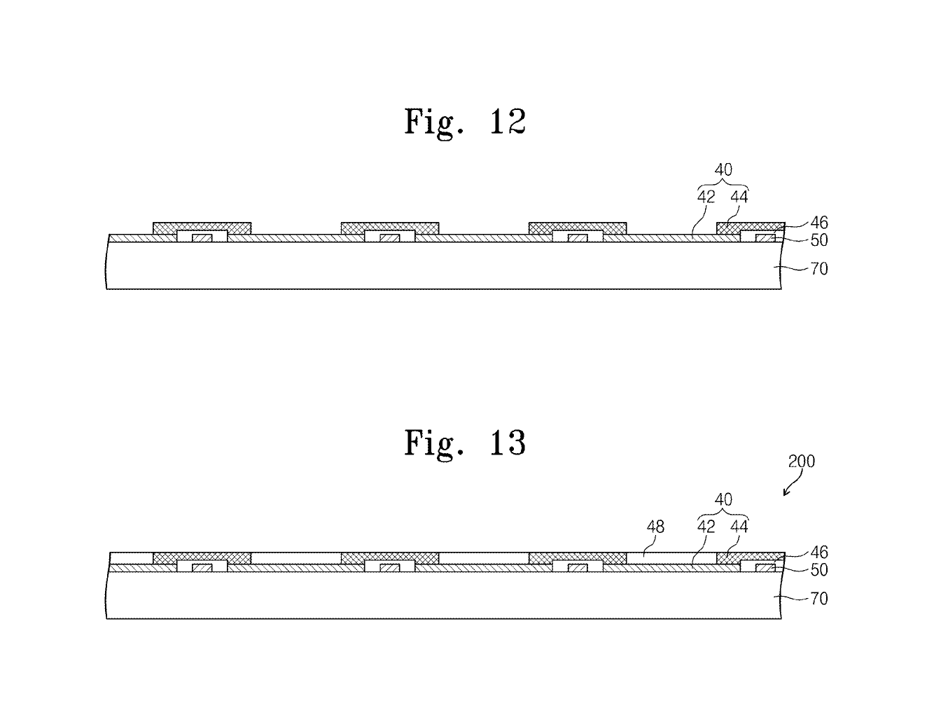

Referring to FIG. 12, the bridge electrodes 44 may be formed on the interlayer insulating layer 46. The bridge electrodes 44 may electrically connect the separation electrodes 42 to each other. The bridge electrodes 44 may include a transparent metal such as ITO and/or IZO. The bridge electrodes 44 may be formed by a depositing process, a photolithography process, and an etching process. The depositing process may include a sputtering process.

Referring to FIG. 13, the planarization layer 48 is formed on the separation electrodes 42 and the third sensor lines 50. The planarization layer 48 may include a silicon oxide layer formed by a depositing process (e.g., a CVD process) and planarized by a polishing process. The polishing process may include a chemical mechanical polishing (CMP) process. As a result, the manufacture of the touch panel 200 may be finished.

Referring to FIG. 2 again, the second polarizing plate 80 and the touch panel 200 are bonded to the display panel 100. The first polarizing plate 70 is bonded to the bottom surface of the display panel 100. The first polarizing plate 70, the display panel 100, the second polarizing plate 80, and the touch panel 200 may be bonded to each other by adhesives. As a result, the manufacturing process of the touch screen display device of the first embodiment is finished.

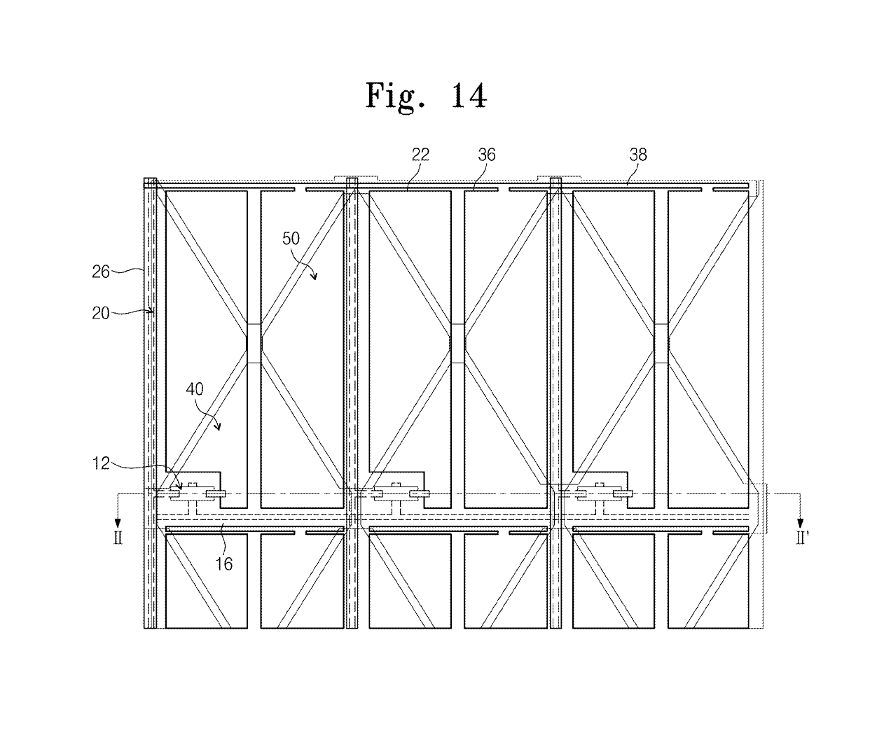

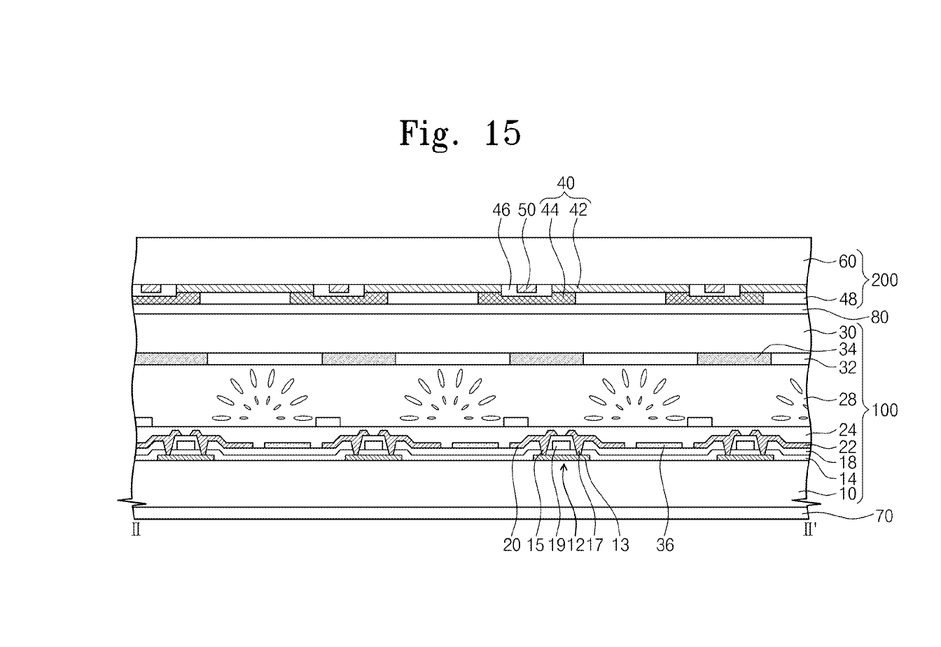

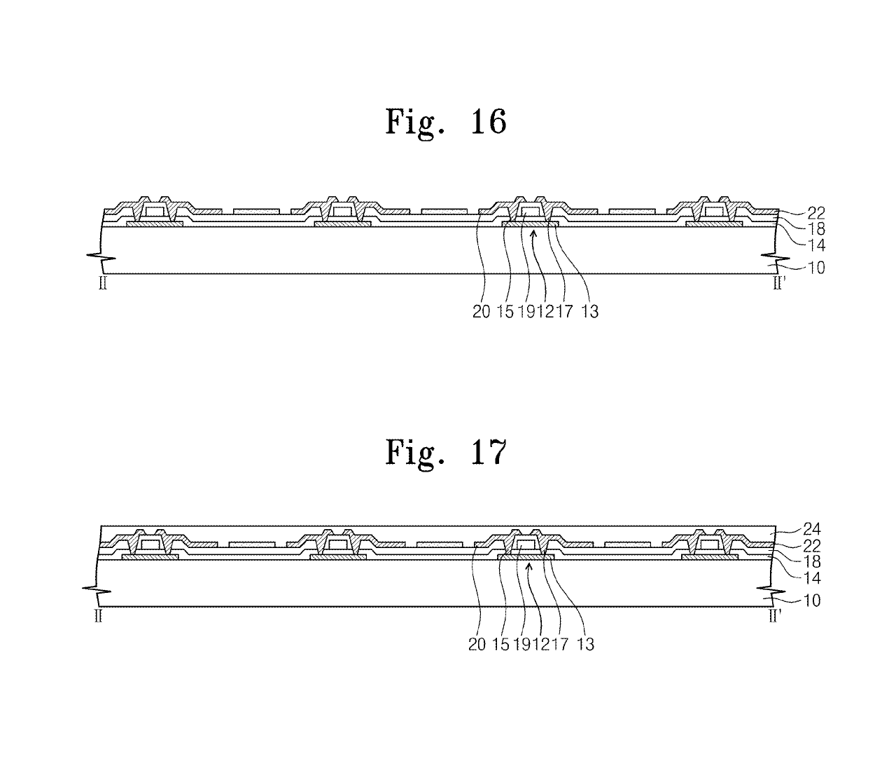

FIG. 14 is a plan view illustrating a touch screen display device according to a second embodiment of the inventive concept. FIG. 15 is a cross-sectional view taken along a line II-II′ of FIG. 14.

Referring to FIGS. 14 and 15, a material of a liquid crystal layer 28 in a touch screen display device according to a second embodiment may be different from that of the liquid crystal layer 28 in the touch screen display device according to the first embodiment. Thus, common electrodes 36 may be disposed on the lower substrate 10 in the touch screen display device according to the second embodiment of the inventive concept.

The common electrodes 36 may be connected to a common line 38. The common electrodes 36 may be disposed at the same level as the pixel electrodes 22. The data lines 20, the pixel electrodes 22, the common electrodes 36, and the common line 38 may be disposed between the upper gate insulating layer 18 and the first passivation layer 24. The common electrodes 36 and the common line 38 may be applied with a ground voltage. The pixel electrode 22 may be applied with a predetermined voltage through the data line 20 and the thin film transistor 12. The predetermined voltage may be a data signal. The data line 20 may transmit the data signal. The thin film transistor may be turned-on, so that the data signal may be applied to the pixel electrode 22. A horizontal electric field may be induced between the pixel electrode 22 and the common electrode 36.

The liquid crystal layer 28 may include an in-plane switching mode liquid crystal. The in-plane switching mode liquid crystal may distort the light polarized by the first polarizing plate 70 when the electric field is not generated. For example, a phase of the light may be changed by about 90 degrees in the liquid crystal layer 28. The in-plane switching mode liquid crystal may transmit the polarized light without the phase change when the electric field generates. Thus, the display panel 100 may display an image.

As described above, the touch panel 200 may generate the input signal corresponding to planar position coordinates of the image displayed at the display panel 100. The second sensor lines 40 may be spaced apart from the third sensor lines 50 by the interlayer insulating layer 46. The second sensor lines 40 may extend in the second direction, and the third sensor lines 50 may extend in the first direction. The first direction may be different from the second direction. The cover substrate 60 covers the second sensor lines 40 and the third sensor lines 50.

The touch panel 200 may sense the variation of the capacitance when the finger of the user touches the cover substrate 60. The touch panel 200 may generate the input signal of the two-dimensional position coordinates. The finger of the user may press the cover substrate 60, so that the cover substrate 60 and the upper substrate 30 may be closed to the lower substrate 10. In other words, the thickness of the liquid crystal layer 28 may be reduced. Thus, the second and third sensor lines 40 and 50 may be closed to the first sensor line 26. At least one of the second and third sensor lines 40 and 50 may sense the capacitance variation corresponding to the distance variation between the first sensor line 26 and at least one of the second and third sensor lines 40 and 50. The capacitance may be inversely proportional to the thickness of the liquid crystal layer 28. Thus, the touch panel 200 may generate the input signal of the three-dimensional position coordinates.

As a result, the touch screen display device according to the second embodiment may three-dimensionally sense the touch of the finger.

A method of manufacturing the touch screen display device will be described in detail hereinafter.

FIGS. 16 to 20 are cross-sectional views illustrating a method of manufacturing a touch screen display device according to a second embodiment of the inventive concept.

Referring to FIG. 16, the thin film transistors 12, the gate lines 16, the data lines 20, the pixel electrodes 22, the common electrodes 36, and the common line 38 may be formed on the lower substrate 10. The thin film transistors 12 may be formed by unit-processes including depositing processes of an active layer 13, a metal layer, and an insulating layer, photolithography processes, and etching processes. The active layer 13 may include poly-silicon formed by a chemical vapor deposition (CVD) process. The active layer 13 may be patterned by some unit-processes. The gate insulating layer 14 and the upper gate insulating layer 18 may include silicon oxide layers formed on an entire surface of the lower substrate 10 by CVD processes. The gate line 16 and the gate electrode 19 may be formed on the gate insulating layer 14. The gate electrode 19 may be formed over the active layer 13 by patterning the metal layer. The gate electrode 19 may be connected to the gate line 16. The upper gate insulating layer 18 may be formed on the gate electrode 19, the gate line 16, and the gate insulating layer 14.

The upper gate insulating layer 18 and the gate insulating layer 14 may be successively patterned to form contact holes (not shown). The contact holes may be spaced apart from the gate electrode 19. The contact holes may penetrate the upper gate insulating layer 18 and the gate insulating layer 14 to expose the active layer 13 at both sides of the gate electrode 19. Source/drain electrodes 15 and 17 may be formed in the contact holes, respectively. The source/drain electrodes 15 and 17 may be connected to the gate line 20 and the pixel electrode 22, respectively. The common electrodes 36 and the common line 38 may be patterned simultaneously with the data line 20 and the pixel electrode 22.

Referring to FIG. 17, the first passivation layer 24 may be formed on the thin film transistors 12, the data lines 20, the pixel electrodes 22, the common electrodes 36, the common line 38, and the upper gate insulating layer 18. The first passivation layer 24 may include a silicon oxide layer formed by a CVD process.

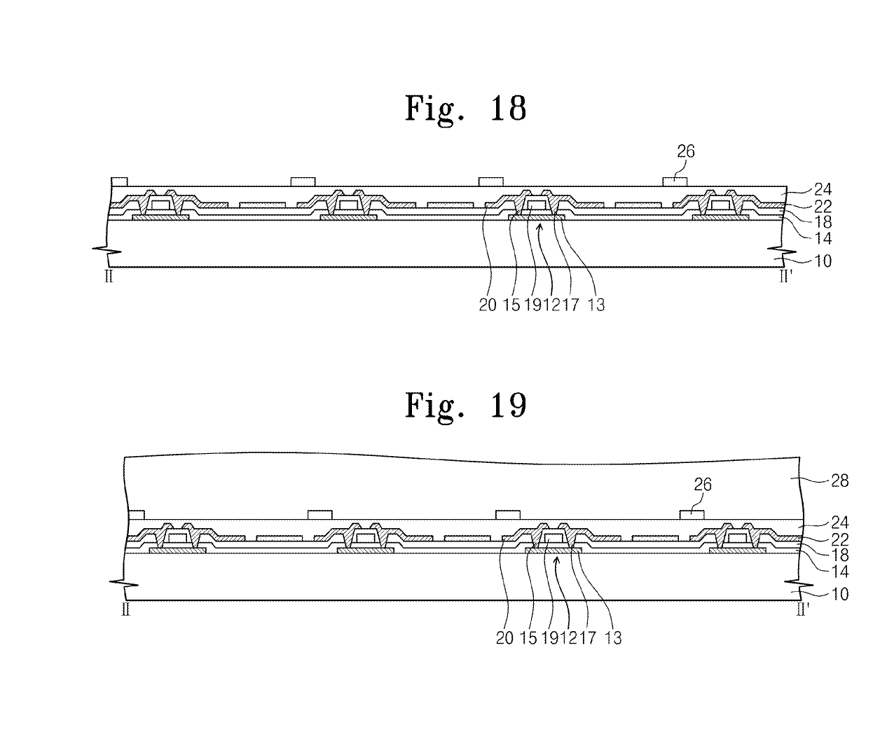

Referring to FIG. 18, the first sensor lines 26 may be formed on the first passivation layer 24. The first sensor lines 26 may include a transparent metal formed by a sputtering process. The first sensor lines 26 may be formed over the data lines 20.

Referring to FIG. 6 again, the color filters 32 and the black matrix layer 34 may be formed on the upper substrate 30. The color filters 32 may include dyes respectively having a red color, a green color, and a blue color. The black matrix layer 34 may include a black dye printed on the upper substrate 30. The dyes may be printed on the upper substrate 30.

Referring to FIG. 19, the liquid crystal layer 28 may be provided on the first sensor lines 26 and the first passivation layer 24 of the lower substrate 10. The liquid crystal layer 28 may drop on the lower substrate 10.

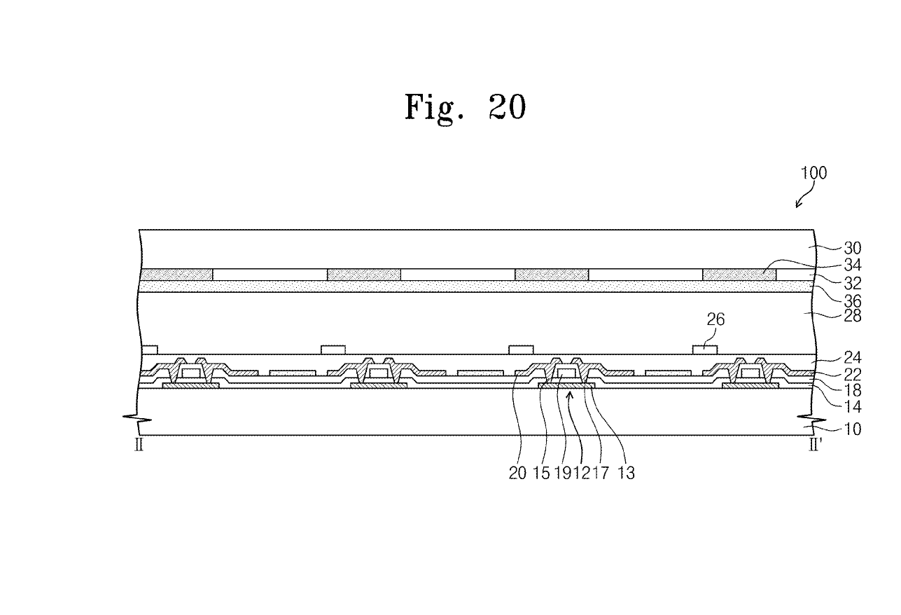

Referring to FIG. 20, the lower substrate 10 and the upper substrate 30 may be bonded to each other. The pixel electrodes 22 are aligned with color filters 32, respectively. The lower substrate 10 and the upper substrate 30 may be bonded to each other to be fixed by a sealant (not shown). Thus, the manufacture of the display panel 100 of FIGS. 14 and 15 may be finished.

Referring to FIG. 10 again, the touch panel 200 is formed. The third sensor lines 50 and the separation electrodes 42 may be formed on a cover substrate 60. The third sensor lines 50 and the separation electrodes 42 may include a transparent metal such as ITO and/or IZO. The third sensor lines 50 and the separation electrodes 42 may be formed by a depositing process, a photolithography process, and an etching process. The depositing process may include a sputtering process.

Referring to FIG. 11, the interlayer insulating layer 46 may be formed on the third sensor lines 50, the separation electrodes 42, and the cover substrate 60. The interlayer insulating layer may include a silicon oxide layer formed by a CVD process.

Referring to FIG. 12, the bridge electrodes 44 may be formed on the interlayer insulating layer 46. The bridge electrodes 44 may electrically connect the separation electrodes 42 to each other. The bridge electrodes 44 may include a transparent metal such as ITO and/or IZO. The bridge electrodes 44 may be formed by a depositing process, a photolithography process, and an etching process. The depositing process may include a sputtering process.

Referring to FIG. 13, the planarization layer 48 is formed on the separation electrodes 42 and the third sensor lines 50. The planarization layer 48 may include a silicon oxide layer formed by a depositing process (e.g., a CVD process) and planarized by a polishing process. The polishing process may include a CMP process. As a result, the manufacture of the touch panel 200 may be finished.

Referring to FIG. 15 again, the second polarizing plate 80 and the touch panel 200 are bonded to the display panel 100. The first polarizing plate 70 is bonded to the bottom surface of the display panel 100. The first polarizing plate 70, the display panel 100, the second polarizing plate 80, and the touch panel 200 may be bonded to each other by adhesives. As a result, the manufacturing process of the touch screen display device of the second embodiment is finished.

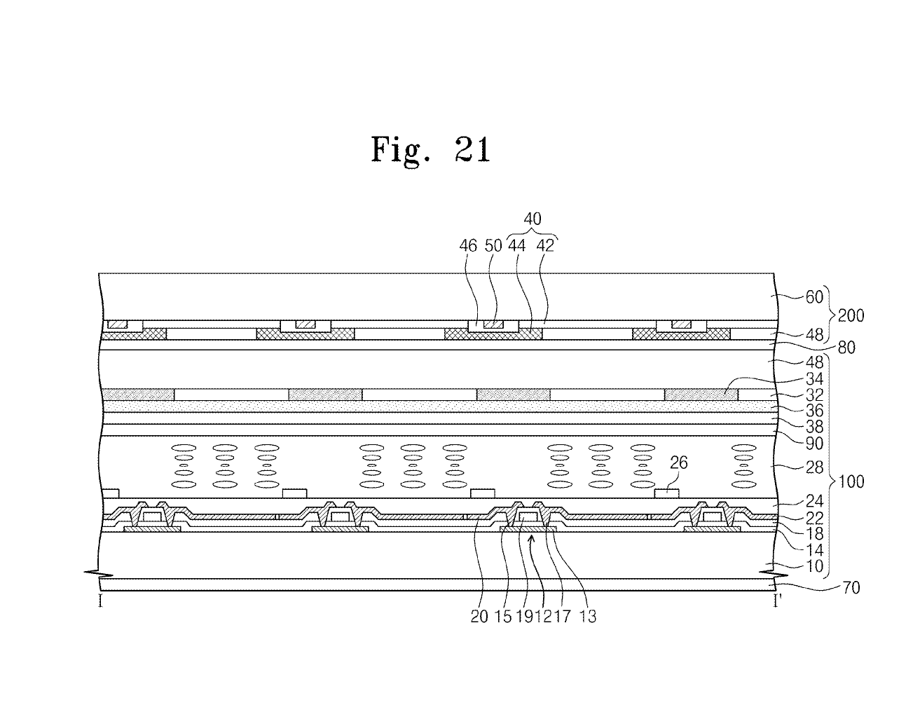

FIG. 21 is a cross-sectional view illustrating a touch screen display device according to a third embodiment of the inventive concept.

Referring to FIG. 21, a touch screen display device according to a third embodiment may further include a second passivation layer 38 and a fourth sensor line 90 on the common electrode 36 in the first embodiment.

The second passivation layer 38 and the fourth sensor line 90 may be disposed between the common electrode 36 and the liquid crystal layer 28. The second passivation layer 38 may insulate the fourth sensor line 90 from the common electrode 36. The second passivation layer 38 may include a silicon oxide layer.

The fourth sensor line 90 may extend in the second direction. The first sensor line 26 and the fourth sensor line 90 may sense a variation of an electrical resistance of the liquid crystal layer 28. The liquid crystal layer 28 may be doped with conductive impurities. The conductive impurities may include carbon. If the thickness of the liquid crystal layer 28 is reduced, a resistance between the first sensor line 26 and the fourth sensor line 90 is reduced. In other words, if the thickness of the liquid crystal layer 28 is reduced, an electric conductivity between the first and fourth sensor lines 26 and 40 increases. As described above, the touch panel 200 may sense the two-dimensional position coordinates. Additionally, the first and fourth sensor lines 26 and 90 may sense the increase of the electric conductivity according to the intensity of the pressing force of the finger.

As a result, the touch screen display device according to the third embodiment may three-dimensionally sense the finger touch.

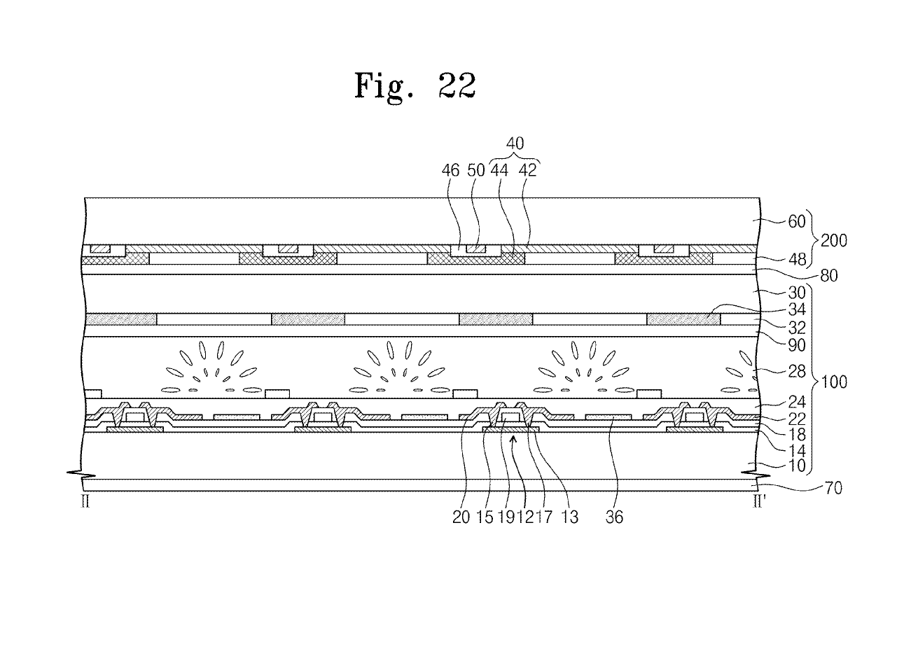

FIG. 22 is a cross-sectional view illustrating a touch screen display device according to a fourth embodiment of the inventive concept.

Referring to FIG. 22, a touch screen display device according to a fourth embodiment may include a fourth sensor line 90 disposed on the top surface 10 of the second embodiment. The fourth sensor line 90 may extend in the second direction. The first sensor line 26 and the fourth sensor line 90 may sense the electrical resistance variation of the liquid crystal layer 28. The liquid crystal layer 28 may be doped with the conductive impurities. The conductive impurities may include carbon. If the arrangement of the liquid crystal layer 28 may be out of order, a resistance between the first sensor line 26 and the fourth sensor line 90 increases. In other words, if the arrangement of the liquid crystal layer 28 may be out of order, the electric conductivity between the first and fourth sensor lines 26 and 90 is reduced. Thus, the first and fourth sensor lines 26 and 90 may sense the reduction of the electric conductivity according to the intensity of the pressing force of the finger.

As a result, the touch screen display device according to the fourth embodiment may three-dimensionally sense the finger touch.

According to embodiments of the inventive concept, the touch screen display device may include the display panel having the first sensor line extending in the first direction, and the touch panel having the second and third sensor lines disposed on the display panel. The touch panel may generate the input signal corresponding to the two-dimensional (planar) position coordinates. At least one of the second and third sensor lines of the touch panel may extend in the second direction crossing the first sensor line. The at least one of the second and third sensor lines may sense the variation of the current or the capacitance from the first sensor line. The current or capacitance variation may be reduced in inverse proportion to the pressure applied to the touch panel.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A touch screen display device comprising:
a first substrate;
a first sensor line extending in a first direction on the first substrate;
an optical switching layer on the first sensor line;
a second substrate on the optical switching layer;
a second sensor line extending in a second direction crossing the first direction on the second substrate;
an interlayer insulating layer on the second sensor line; and
a third sensor line extending in the first direction on the interlayer insulating layer,
wherein at least one of the second and third sensor lines senses a variation of a current or a capacitance from the first sensor line when a distance between the first substrate and the second substrate is changed.

2. The touch screen display device of claim 1, further comprising:
a gate line and a data line disposed between the first substrate and the first sensor line.

3. The touch screen display device of claim 2, further comprising:
a pixel electrode in a pixel region defined by the gate line and the data line; and
a thin film transistor connected to the pixel electrode.

4. The touch screen display device of claim 3, further comprising:
a first passivation layer covering the pixel electrode and the thin film transistor, the first passivation layer disposed between the first sensor line and the first substrate.

5. The touch screen display device of claim 4, further comprising:
a common electrode spaced apart from the pixel electrode.

6. The touch screen display device of claim 5, wherein the common electrode is disposed between the optical switching layer and the second substrate.

7. The touch screen display device of claim 6, wherein the optical switching layer includes a nematic mode liquid crystal.

8. The touch screen display device of claim 5, wherein the common electrode is disposed between the first substrate and the first passivation layer.

9. The touch screen display device of claim 8, wherein the optical switching layer includes an in-plane switching mode liquid crystal.

10. The touch screen display device of claim 5, further comprising:
a fourth sensor line disposed between the second substrate and the optical switching layer and extending in the second direction.

11. The touch screen display device of claim 10, further comprising:
a second passivation layer disposed between the fourth sensor line and the common electrode.

12. The touch screen display device of claim 10, wherein the optical switching layer includes a liquid crystal layer doped with conductive impurities.

13. The touch screen display device of claim 12, wherein the conductive impurities include carbon.

14. The touch screen display device of claim 1, wherein the second sensor line includes bridge electrodes disposed between the second substrate and the interlayer insulating layer, and separation electrodes electrically connected to each other by the bridge electrodes at both sides of the interlayer insulating layer.

15. The touch screen display device of claim 14, further comprising:
a third substrate covering the second substrate, the separation electrodes, and the third sensor line.

16. The touch screen display device of claim 15, wherein the third substrate includes a glass or plastic.

17. The touch screen display device of claim 16, further comprising:
a planarization layer planarizing a space between the bridge electrodes and disposed between the second substrate and third substrate.

18. The touch screen display device of claim 17, further comprising:
a first polarizing plate disposed under the first substrate; and
a second polarizing plate disposed between the planarization layer and the second substrate.

19. A touch screen display device comprising:
a display panel including first and second substrates opposite to each other, an liquid crystal layer between the first and second substrates, a first sensor line extending in a first direction between the liquid crystal layer and the first substrate, and a second sensor line extending in a second direction crossing the first direction; and
a touch panel including a third sensor line extending in the first direction on the display panel, an interlayer insulating layer on the third sensor line, and a fourth sensor line extending in the second direction on the interlayer insulating layer.

20. The touch screen display device of claim 19, further comprising:
a first polarizing plate disposed under a bottom surface of the display panel opposite to the touch panel, the first polarizing plate polarizing light in the first direction; and
a second polarizing plate disposed between the display panel and the touch panel, the second polarizing plate polarizing light in the second direction.
